(19) United States
(12) Patent Application Publication
(10) Pub. No.: US 2008/0289244 A1
(43) Pub. Date: Nov. 27, 2008

(54) Fishing lure having an action halo

(75) Inventor: Danny R. Parks, Daphne, AL (US)

Correspondence Address: BRADLEY ARANT ROSE & WHITE LLP, 200 CLINTON AVE. WEST, SUITE 900, HUNTSVILLE, AL, 35801, US

(73) Assignee: WAR-TAC Outdoors, Inc., Stapleton, AL (US)

(21) Appl. No.: 11/807,106

(22) Filed: May 25, 2007

(51) Int. Cl. A01K 85/00

(52) U.S. Cl. 43/42.3; 43/42.24; 43/42.02

(57) ABSTRACT

The present invention provides for a variety of soft plastic fishing lures having an enlarged soft plastic attachment as part of the leading edge of the bait. The soft plastic attachment, preferably disk shaped and concave, provides for unique back and forth swimming motion in the leading edge of the bait and, when fished on the surface, creates a wake of water and produces vibration. The soft plastic attachment also adds additional weight to the front of the bait, causing it to fall in a natural lifelike position, and also allows the hook eye and line knot to be embedded into th

### FIELD OF THE INVENTION

The invention relates generally to a fishing lure having an enlarged, soft plastic attachment on the leading edge, or head, of the bait. More specifically, the invention relates to soft plastic fishing lures having an enlarged, soft plastic attachment on the leading edge, or head, of the bait which increases drag, creates a side-to-side swimming motion, and creates a lifelike presentation to fish.

### BACKGROUND ART

Soft plastic baits are well known fishing lures, both in freshwater and saltwater. Soft plastic baits offer the ability to embed the shank of the hook, and the eye of the hook where the fishing line is attached, into the soft body plastic, thereby making the fishing lure more weedless. Soft plastic baits also provide a more lifelike appearance and texture to the bait, thereby enhancing the potential for a fish strike. Soft plastic baits can have a variety of shapes, sizes, and colors, and can be shaped to imitate natural fish prey, including worms, lizards, baitfish, and crawfish, just to name a few.

Soft plastic baits can also be fished on the surface, normally with no weight attached, at some suspended depth using small lead weights, or on the bottom utilizing heavier lead weights along with the fishing lure.

Prior art soft plastic baits traditionally have (1) a convex, streamlined, and aerodynamic head, or leading edge, (2) a main body, and (3) often some type of appendages, for example arms, legs, or a tail. The streamlined and aerodynamic head of these lures minimizes drag through the water. As the water flows over the body, it interacts with the appendages causing a fluttering or rotation, thereby bringing additional attention to the bait. However, due to the streamlined and aerodynamic head, the leading edge of the lure will have minimal, if any, side to side motion as it is being pulled through the water. If side to side swimming motion is desired, the fisherman must normally manipulate his or her fishing pole in a side to side manner.

Moreover, the leading edge, or head, of the bait is often substantially the same size as the body of the lure. Depending on the weight and density of the bait, when the bait is not being pulled through the water, it may fall to the bottom. However, with minimal weight on the leading edge of the bait, the bait will often not fall in a lifelike manner. If a lead weight is used with the bait, the bait will often fall faster than desired, and the weight may also lessen the ability of the lure to stay weedless. Additionally, the weight of many of the soft plastic prior art baits alone is too light for casting significant distances, so a separate weight must often be used to give additional casting weight to the bait.

The traditional soft plastic baits and lures can also be used in connection with other fishing lures, for example, a spinnerbait or jig. In these embodiments, the soft plastic lure is placed on the hook of the spinnerbait or jig, and enhances the presentation to the fish.

Some pre-existing baits utilize a deep, non-uniform mouth or reservoir on the front of the bait to create turbulence as the bait is pulled through the water. Most of these are hard, solid baits configured as top-water, “chugger”-style or “stick” baits. They are “popped” for short distances to emulate an injured baitfish, and create a splash and water vibration. The action of the bait is erratic and is not designed to simulate natural swimming motion. Applicant is also aware of one pre-existing soft-plastic worm, the Poppin' Work™, that utilized a large, deep mouth opening on the leading edge of the worm, with multiple cut outs on the sides of the mouth to allow water to escape the side of the mouth. The Poppin' Worm™ was primarily designed to create a splash as it was fished on top of the water. The large mouth was not designed to be used in connection with traditional worm weights for fishing on the bottom because the large, deep mouth would unnaturally dig up material and mud if fished on the bottom, and was more susceptible to hanging on underwater structure. The Poppin' Worm™ is believed to no longer be offered for sale.

### SUMMARY OF THE INVENTION

The present invention relates to a soft plastic bait having an enlarged soft plastic attachment formed as part of the leading edge, or head, of the bait (or lure). The enlarged soft plastic attachment, as further described below, is referred to herein as an action “halo.” The size, shape, and thickness of the action halo may be adjusted to accommodate the size of the bait it is being used in connection with. The halo is preferably circular, or disk shaped, although other shapes can be used. The halo also preferably has a slightly concave front or leading edge, although it can also have a flat face. Unlike the streamlined, aerodynamic prior art soft plastic lures, the enlarged action halo creates considerably more drag and produces a side to side swimming motion at the leading edge as it pushes water away from the action halo. As the lure is being pulled through the water, it also produces vibration, and when on the surface, a wake, alerting fish of its presence, and thereby promoting a strike.

The action halo may also serve as a skirt support when used on a jig, spinner bait, or other skirted bait by preventing the skirt from collapsing around the hook.

The action halo can be used on any type of soft body plastic bait. Soft plastics can be formed in many shapes and sizes, including, for example, worms, lizards, crawfish, tube baits, grubs, “creature” style baits, flipping baits, “flies” and finesse baits.

In some aspects, the invention relates to a soft plastic bait or lure that features an enlarged soft plastic action halo that creates a side to side swimming motion.

In other aspects, the invention relates to a soft plastic bait or lure that features an enlarged, concave attachment on the leading edge that displaces water in different amounts as it is retrieved creating a wagging motion.

In other aspects, the invention relates to a soft plastic bait or lure that allows for the eye of the hook and line knot to be embedded into an action halo, thereby protecting it from damage.

In other aspects, the invention relates to a soft plastic bait or lure that includes additional weight on the leading edge of the bait or lure causing it to fall in a natural, lifelike manner and causing the trailing edge of the bait or lure to “stand up” when not being retrieved. The additional weight also assists in casting the lure farther distances without the need for additional lead weights.

In other aspects, the invention relates to a soft plastic fishing lure comprising a soft plastic body having a front end and a back end, said body configured receive a hook shank, and a soft plastic disk shaped attachment connected to the front end of the body, wherein the disk-shaped attachment has a front face and a rear face, said front face being concave, and wherein the soft plastic disk shaped attachment has a cross sectional area larger than the cross sectional area of the front end of said body and wherein the concave front face of the disk shaped attachment forms the leading edge of the soft plastic fishing lure as is it pulled through the water.

In other aspects, the invention relates to a soft plastic fishing lure comprising a soft plastic attachment having a front face and a rear face; and a soft plastic body connected to the soft plastic attachment, said soft plastic body having a front end and a back end and at least one appendage, wherein the soft plastic attachment has a cross sectional area larger than the cross sectional area of the front end of said body and wherein the front face of the attachment forms the leading edge of the soft plastic fishing lure as is it pulled through the water.

In other aspects, the invention relates to a soft plastic fishing lure comprising at least one soft plastic attachment having a front face and a rear face having a thickness around the perimeter of said soft plastic attachment between said front face and said rear face of between approximately 0.1 and 0.4 inches; and a soft plastic body connected to the soft plastic attachment, said soft plastic body having a front end and a back end.

Other aspects and advantages of the invention will be apparent from the following description and the appended claims.

### BRIEF DESCRIPTION OF DRAWINGS

FIGS. 1a and 1b depict a side view and top view, respectively, of one embodiment of a “thug” fishing lure having the action halo.

FIGS. 2a and 2b depict a side view and top view, respectively, of one embodiment of a frog style fishing lure having the action halo.

FIGS. 3a and 3b depict a side view and top view, respectively, of one embodiment of a grub style fishing lure having the action halo.

FIGS. 4a and 4b depict a side view and top view, respectively, of one embodiment of a baitfish style fishing lure having the action halo.

FIGS. 5a and 5b depict a side view and top view, respectively, of one embodiment of a “creature” style fishing lure having the enlarged action halo.

### DETAILED DESCRIPTION

While the following description details the preferred embodiments of the present invention, it is understood that the invention is not limited in its application to the details of construction and arrangement of the parts illustrated in the accompanying drawings, since the invention is capable of other embodiments and of being practiced in various ways.

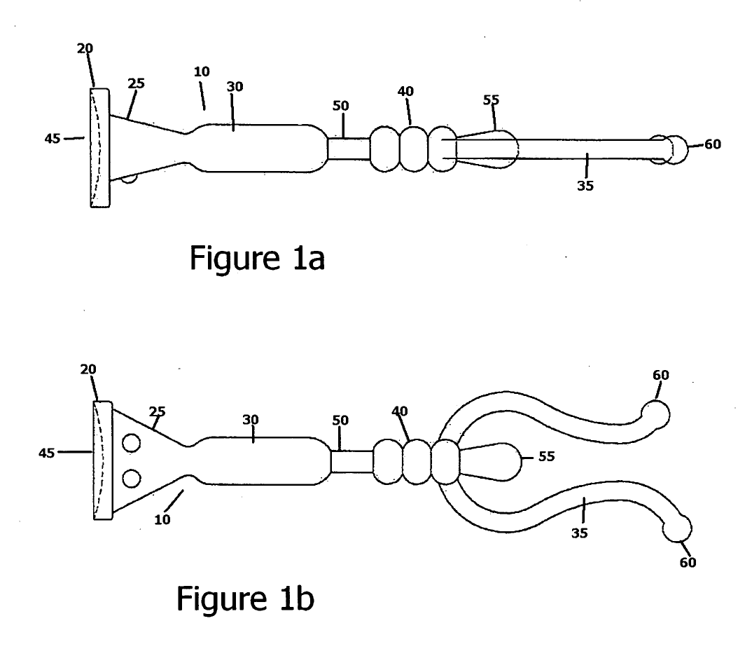

FIGS. 1a and 1b show one embodiment of the enlarged action halo in use with a soft plastic bait, and is only an exemplary embodiment of one type of configuration for the lure. This embodiment is generally referred to as a “thug” soft plastic bait. The lure 10 depicted in FIGS. 1a and 1b generally comprises an action halo 20, a head 25, a body 30, an optional appendages 35. The body may also have ridges 40.

One exemplary embodiment of the “thug” bait depicted in FIG. 1 is approximately 5 to 8 inches in total length, comprising a head 25 approximately 0.70 inches to 1 inch long, a body 30 approximately 2.5 to 4.5 inches long, and the appendages 35 approximately 1.5 to 3.5 inches long. In this embodiment, the head 25 has an approximate diameter of 0.6 to 1.0 inches at the front end of the head 25 and a diameter of approximately 0.2 to 0.4 inches at the back end of the head 25 where it meets the body 30. In the preferred embodiment, the body 30 is round, i.e., it has a circular cross section. The body 30 may have a diameter from 0.3 to 0.7 inches. If the diameter of the body 30 is larger than the back end of the head 25, a “neck” is formed. The body 30 may have varying shapes and cross section along its length, and may have a tail section. In one embodiment, as depicted in FIGS. 1a and 1b, part of the body 30 includes a tail section 50 that may comprise a small tube with a diameter of approximately 0.2 to 0.25 inches, and approximately 0.4 to 0.5 inches in length. The tail section 50 may also have ridges 40 that may each have a diameter of approximately 0.45 to 0.55 inches, and each have a length of approximately 0.25 to 0.35 inches. As also depicted in FIGS. 1a and 1b, the end of the tail section may have a round cone shaped tail 55. The appendages 35 may have a diameter of approximately 0.15 to 0.25 inches, and may terminate with a ball type hand 60 having a diameter from approximately 0.25 to 0.35 inches. The appendages 35 may also have other ends, for example, crawfish claws, teardrop paddles, spike tails, etc. (not depicted). The appendages 35 may be different lengths, for example one 2.5 inches and the other 2.75 inches long. The action halo 20 for this embodiment is approximately 0.15 to 0.30 inches thick (from the front face to the rear face), and has a diameter of approximately 1 inch to 1.5 inches. As seen in FIG. 1, the action halo 20 is substantially larger in cross sectional area than any part of the body 30 or the head 25.

The action halo 20 is made of soft plastic, and preferably poured as part of the bait during manufacture as part of the head or leading edge of the bait. As depicted in FIGS. 1a and 1b, the action halo 20 is preferably disk shaped, and preferably uniform around the perimeter, i.e., no cut outs or portions removed. The shape of the action halo 20 may be altered, for example oval or square, although circular or disk shaped is preferred. The diameter and thickness of the action halo 20 is adjusted to accommodate the size of the bait. In its preferred embodiment, the action halo 20 has some thickness, having a front face (the leading edge as the bait is pulled through the water) and a rear face, with the rear face of the action halo 20 preferably flat where the body 30 or head 25 meet the action halo 20. Alternatively, for the embodiment in FIGS. 1a and 1b, the action halo 20 can be integrated directly with the head 25 (not depicted), with the action halo 20 having varying diameter. The head 25 is optional. If eliminated, the body 30 would directly join the action halo 20.

The action halo 20 preferably has a slightly concave front face 45, or leading edge, although a flat surface may also be acceptable. For example, if the thickness of the action halo 20 is approximately 0.20 inches, the maximum depth of the concavity may be only 0.025 inches to 0.1 inches. In its preferred embodiment, the concavity is substantially uniform across the front face. As depicted in FIGS. 1a and 1b, in the preferred embodiment, the action halo 20 is substantially larger in diameter than the body 30 of the lure 10. In many embodiments, including those discussed in FIGS. 1-5, the cross sectional area of the action halo 20 will be from 1.5 times to more than 4 times the cross sectional area of the front end of the body 30 connected to the action halo 20.

The action halo 20 is not aerodynamic as it is pulled through the water and, in fact, creates substantial drag as compared to the prior art soft plastic lures with streamlined heads, or leading edges. As the lure having an action halo 20 is pulled through the water, water is pressed against the concave front face of the action halo 20, and is disbursed in different amounts off the sides of the action halo 20, thereby producing a unique back and forth swimming action at the leading edge of the lure 10. If the lure 10 is fished on the surface, the action halo 20 also creates a substantial wake of water away from the lure 10 that is being pulled through the water. The wake of the water, when fished on the surface, and the back and forth swimming action of the lure 10 produces vibration, alerting fish of the lure 10's presence and promoting a strike. Through various retrieves, the action halo 20 also may produce bubbles increasing the possibility of a strike.

The addition of the action halo 20 to the leading edge of the lure also adds substantial weight to the leading edge of the lure 10, causing it to fall through the water in a natural life-like position when not being retrieved. This also causes the trailing edge of the lure 10 to “stand up” creating additional strike possibilities. The lure 10 having an action halo 20 can be fished at different depths by altering the speed of the retrieve, or if desired, adding a variety of weight sizes. One additional advantage of the additional weight due to the action halo 20 is that it can be cast further than traditional baits without the need for traditional lead weights. The elimination of the traditional weights also improves the ability of the lure to remain weedless.

The eye of the hook and the knot of the fishing line can be embedded into the soft plastic of the action halo 20, protecting it from damage from the structure it is being fished around or in, for example, a dock or submerged timber.

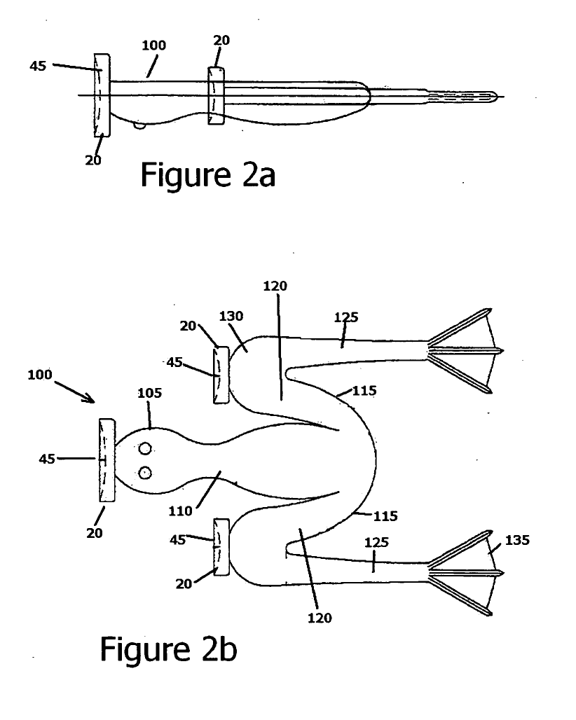

Another embodiment of the action halo 20 used in connection with a soft plastic bait is depicted in FIGS. 2a and 2b. FIGS. 2a and 2b depict a soft plastic frog 100. Although multiple configurations are possible, the preferred embodiment of the frog utilizing the action halo 20 is depicted.

As shown in FIG. 2, the frog 100 consists of a head section 105, a body section (or torso) 110, and leg sections 115. Alternative configurations are obviously possible, with the head section 105 and body section 110 being combined into a single section being one alternative. The leg sections 115 may have a thigh segment 120 and a lower leg segment 125. In the preferred embodiment, the thigh segment 120 is attached at the lower end of the body section 110, lies essentially proximate to the contour of the body section 110, and extends forward toward the head section 105. Alternatively, the thigh segment 120 could extend outwardly and essentially perpendicular to the body section 110 and/or could be attached almost anywhere to the body section 110. The lower leg segment 125 is attached to the thigh segment 120 at a knee joint 130, and the lower leg segment 125 preferably extends downwardly from the knee joint 130, essentially parallel to the longitudinal axis of the body section 110. The lower leg segment 125 may have three toed webbed feet 135.

An action halo 20 is preferably attached at or near the knee joint 130, although it could also be placed along the thigh segment 120. When the frog 100 is pulled through the water, the increased resistance against the action halo 20 pushes the leg sections 115 back, thereby creating a life-like kicking motion. When the retrieve is stopped, the leg sections 115 preferably return to its preferred position with the thigh segment 120 essentially proximate to the body section 110. As depicted in FIG. 2, an action halo 20 may also be used in front of the head section 105 of the frog 100, but is not required.

As discussed with respect to FIG. 1, the action halo 20 used in connection with the frog lure 100 are preferably disk shaped with a slight concave shape, although other shapes and configurations can be used. The action halos 20 are substantially larger in cross sectional area than the portion of the frog lure 100 to which they are attached, the head section 105 and knee joints 130 in FIGS. 2a and 2b. In one embodiment of the frog lure 100, the action halo 20 on the leading edge of the frog lure 100, directly in front of the head section 105, may be approximately 0.75 inches to 1 inch in diameter, and approximately 0.15 inches to 0.3 inches thick. In this embodiment, the action halo 20 on the leg sections 115 may be approximately 0.5 to 0.7 inches in diameter, and approximately 0.15 to 0.3 inches thick. The length of the combined head section 105 and body section 110 may be approximately 2.5 to 4 inches. The action halo 20 preferably has a slightly concave front 45, or leading edge, although a flat surface may also be acceptable. For example, if the thickness of the action halo 20 is approximately 0.20 thick, the depth of the concavity may be only 0.025 inches to 0.1 inches.

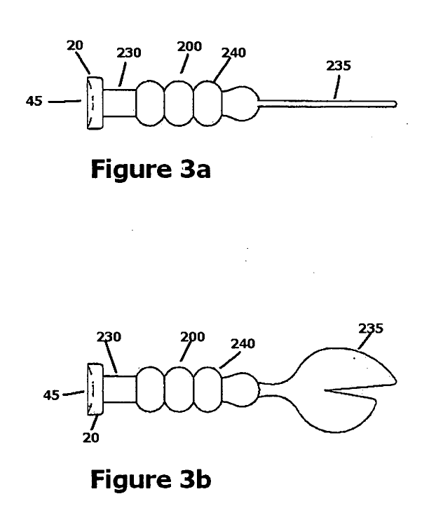

Another embodiment of the action halo 20 used in connection with a soft plastic bait is depicted in FIGS. 3a and 3b. FIGS. 3a and 3b depict a grub style bait 200. The lure 200 depicted in FIGS. 3a and 3b generally comprises an action halo 20, a body 230, optional appendages 235, or tail, and optional ridges 240. In one embodiment of the grub style bait 200, the length of the entire bait may be approximately 2.75 inches to 3.5 inches. In this embodiment, the action halo 20 may have a diameter of approximately 0.45 to 0.6 inches, and a thickness of approximately 0.12 to 0.20 inches. In the preferred embodiment, the action halo 20 is concave 45, with a maximum concavity depth of approximately 0.04 to 0.08 inches, and is uniform around the perimeter. The optional appendage 235, or tail, in this embodiment may be approximately 1.25 to 1.65 inches in length.

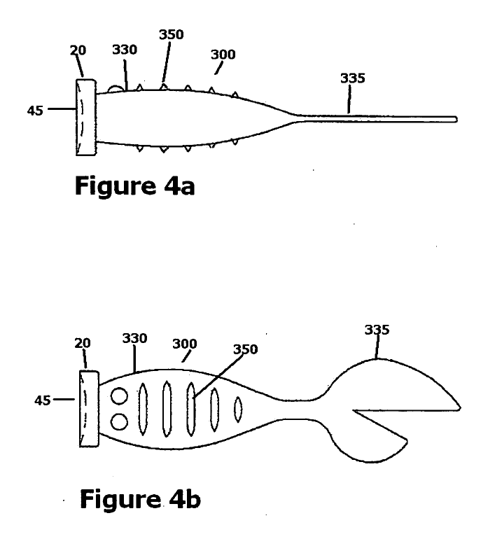

Another embodiment of the action halo 20 used in connection with a soft plastic bait is depicted in FIGS. 4a and 4b. FIGS. 4a and 4b depict a baitfish style bait 300. The lure 300 depicted in FIG. 4 generally comprises an action halo 20, a body 330, optional appendage 335, or tail, and raised fins 350. In one embodiment of the baitfish style bait 300, the length of the entire bait may be approximately 3.5 inches to 5 inches. In this embodiment, the action halo 20 may have a diameter of approximately 0.6 to 1.0 inches, and a thickness of approximately 0.15 to 0.25 inches. In the preferred embodiment, the action halo 20 is concave 45, with a maximum concavity depth of approximately 0.05 to 0.10 inches. The optional appendage 335, or tail, in this embodiment is approximately 1.25 to 2 inches in length. The cross section of the body 330 of this embodiment can be almost any shape designed to simulate a fish, including circular or lemon shaped.

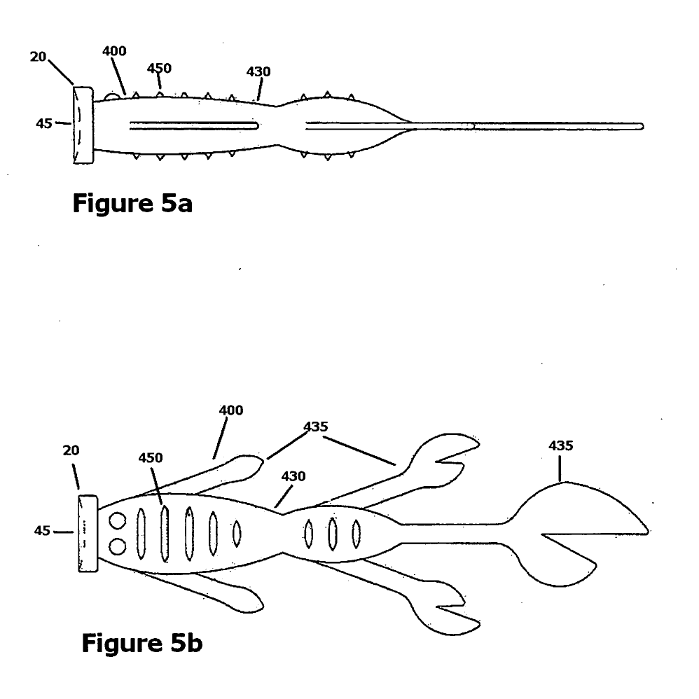

Another embodiment of the action halo 20 used in connection with a soft plastic bait is depicted in FIGS. 5a and 5b. FIGS. 5a and 5b depict a “creature” style bait 400. The lure 400 depicted in FIG. 5 generally comprises an action halo 20, a body 430, optional appendages 435, and raised fins 450. In one embodiment of the creature style bait 400, the length of the entire bait may be approximately 5 inches to 7 inches. In this embodiment, the action halo 20 may have a diameter of approximately 0.6 to 1.0 inches, and a thickness of approximately 0.15 to 0.25 inches. In the preferred embodiment, the action halo 20 is concave 45, with a concavity depth of approximately 0.05 to 0.10 inches. The optional appendages 435, can be in the nature of arms, legs, and/or a tail. In this embodiment the arms can be may be approximately 0.5 to 1.5 inches long, and the tail may be 1.5 to 3 inches long. The cross section of the body 430 of this embodiment can be almost any shape, including circular or lemon shaped.

The action halo 20 may also serve as a skirt support when used on a jig, spinnerbait, or other skirted lure. In most skirted lures, the skirt is attached near the head of the bait, with a relatively unobstructed hook shank. When the lure having an action halo 20 is embedded on the hook portion, the action halo is moved up the hook toward the head of the primary bait (i.e., the jig, spinnerbait, etc.). The increased diameter of the action halo 20 prevents the skirt from collapsing around the hook when being pulled through the water, thereby allowing the skirt to flow as it was designed, and promoting more strikes.

The body of the lure having the action halo 20 may also utilize chambers in which users may insert rattles or other mechanisms that vibrate when the bait is moved.

The action halo 20 may be used in conjunction with any soft plastic baits including, top water baits, jerk baits, hopping baits, flipping baits, jig baits, lizard baits, crawfish baits, worm-rigged baits, and any other soft plastic lures. The sizes, shapes, and configurations of the lures are limitless. The embodiments depicted in the figures and the various aspects of the lures described in the specification are simply exemplary embodiments. The dimensions can be modified, various aspects included or excluded, and the general shape altered. The depicted and described characteristics of the lures are not limiting on the size and shape of the lures that can utilize the action halo 20. The soft plastic baits may be manufactured with industry standard plastics and materials well known in the art. The color and texture of the baits and lures can be offered in any number of combinations, and may include reflective or colored sparkles embedded in the plastics.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A soft plastic fishing lure comprising:
a. a soft plastic body having a front end and a back end, said body configured to receive a hook shank, and
b. a soft plastic disk shaped attachment integrally formed and affixed to the front end of the body, wherein the disk-shaped attachment has a front face and a rear face, said front face being concave,
wherein the soft plastic disk shaped attachment has a cross sectional area larger than the cross sectional area of the front end of said body and wherein the concave front face of the disk shaped attachment forms the leading edge of the soft plastic fishing lure as is it pulled through the water.

2. The soft plastic fishing lure of claim 1 wherein the cross sectional area of the soft plastic disk shaped attachment is more than fifty percent larger than the cross sectional area of the front end of said body.

3. The soft plastic fishing lure of claim 1 wherein the soft plastic disk shaped attachment has a uniform perimeter.

4. The soft plastic fishing lure of claim 1 wherein the thickness around the perimeter from the front face to the rear face of the soft plastic disk shaped attachment is between approximately 0.1 and 0.4 inches.

5. The soft plastic fishing lure of claim 4 wherein the soft plastic disk shaped attachment has a diameter between about 0.4 inches and 1.5 inches.

6. The soft plastic fishing lure of claim 5 wherein concavity of the front face is uniform and the maximum depth of the concavity is between approximately 0.02 and 0.2 inches.

7. A soft plastic fishing lure comprising:
a. a soft plastic action halo having a front face and a rear face; and
b. a soft plastic body connected to the soft plastic action halo, said soft plastic body having a front end and a back end and at least one appendage,
wherein the soft plastic action halo has a cross sectional area larger than the cross sectional area of the front end of said body and wherein the front face of the soft plastic action halo forms the leading edge of the soft plastic fishing lure as it is pulled through the water.

8. The soft plastic fishing lure of claim 7 wherein the front face of the soft plastic action halo is concave.

9. The soft plastic fishing lure of claim 7 wherein the soft plastic action halo has a uniform perimeter and is disk shaped.

10. The soft plastic fishing lure of claim 8 wherein said soft plastic action halo has a thickness around the perimeter between said front face and said rear face of between approximately 0.1 and 0.4 inches.

11. The soft plastic fishing lure of claim 10 wherein the maximum depth of the concavity of the front face of the action halo is between approximately 0.02 and 0.2 inches.

12. The soft plastic fishing lure of claim 7 wherein the cross sectional area of the soft plastic action halo is more than 50 percent greater than the cross sectional area of the front end of said body.

13. The soft plastic fishing lure of claim 7 further comprising a head section having a front end and a back end, wherein said front end of the head section is connected to the soft plastic action halo and said back end of the head section is connected to the front end of said body, said front end of the head section having a cross sectional area smaller than the cross sectional area of the soft plastic action halo and at least two appendages of different lengths connected to said body, said appendages terminating in a ball type hand having a diameter of between 0.25 and 0.35 inches in diameter.

14. The soft plastic fishing lure of claim 13 wherein the cross section of the head section and body is circular in shape.

15. A soft plastic fishing lure comprising:
a. at least one soft plastic action halo having a front face and a rear face having a thickness between said front face and said rear face around the perimeter of said soft plastic action halo of between approximately 0.1 and 0.4 inches; and
b. a soft plastic body connected to the soft plastic action halo, said soft plastic body having a front end and a back end.

16. The soft plastic fishing lure of claim 15 wherein the soft plastic body is formed in the shape of a frog comprising a head, torso, and legs and wherein at least one of said soft plastic action halos is connected to the legs of the frog body.

17. The soft plastic fishing lure of claim 15 wherein the front face of the soft plastic action halo is concave.

18. The soft plastic fishing lure of claim 16 wherein the front face of the soft plastic action halo is concave.

19. The soft plastic fishing lure of claim 15 wherein the soft plastic action halo has a uniform perimeter and is disk shaped.

20. The soft plastic fishing lure of claim 17 wherein the maximum depth of the concavity of the front face of the action halo is between approximately 0.02 and 0.2 inches.
